(19) United States
(12) Patent Application Publication
(10) Pub. No.: US 2026/0062961 A1
(43) Pub. Date: Mar. 5, 2026

(54) DOOR LOCK

(71) Applicant: Mingzhu YANG, Zhanjiang City (CN)

(72) Inventor: Mingzhu YANG, Zhanjiang City (CN)

(73) Assignee: HONG KONG QINGZHOU WANSHAN INDUSTRIAL CO., LIMITED, TSIM SHA TSUI (HK)

(21) Appl. No.: 19/383,743

(22) Filed: Nov. 9, 2025

(30) Foreign Application Priority Data
Oct. 23, 2025 (CN) 202522252436.6

(51) Int. Cl. E05B 57/00; E05B 15/04; E05B 53/00

(52) U.S. Cl. CPC E05B 57/00; E05B 53/003; E05B 2015/0448

(57) ABSTRACT

A door lock, including: a lock bolt, a lock catch assembly and a switching control assembly. The lock bolt is configured to rotate with a rotation of the door. When the door is in a closed state, the lock catch assembly is in a fastening state, and the lock bolt is fastened by the lock catch assembly. The switching control assembly is fixedly connected to the outer side of the door. When the door is in the closed state, the switching control assembly is configured for switching the lock catch assembly from the fastening state to a releasing state, and during a process of switching the lock catch assembly from the fastening state to the releasing state, the lock bolt automatically pops out of the lock catch assembly and drives the door to rotate to disengage from the closed state.

### CROSS-REFERENCE TO RELATED APPLICATIONS

This application claims foreign priority of Chinese Patent application No. 202522252436.6, filed on Oct. 23, 2025 in the China National Intellectual Property Administration, the disclosures of all of which are hereby incorporated by reference.

### TECHNICAL FIELD

The present disclosure relates to the technical field of lock, in particular to a door lock capable of achieving a continuous sequence of actions: “operation-unlocking-automatic popping open.”

### BACKGROUND

Traditional door locks have long suffered from a core flaw in terms of user experience and operational logic: after the user unlocks the door from the outside using one hand, the door cannot automatically pop open through the internal mechanism of the lock itself. The user must still use the other hand to push the door open manually. This “freeing one hand” problem creates significant inconvenience and a fragmented experience in daily scenarios such as carrying items or holding a baby. As a result, existing designs show clear shortcomings in terms of ergonomic design and functional integration.

Conventional door lock catch mechanisms are limited to purely mechanical engagement and disengagement functions. Their design philosophy remains at a binary “locked-unlocked” state transition, without considering the aspects of “kinetic energy transfer upon unlock” or “assistance in door movement.” Consequently, even after a user successfully operates the external control component, additional force is still required to overcome the sealing resistance of the door gap or the static friction of the hinges, preventing truly seamless one-handed operation.

A mature solution that can reliably achieve a continuous “operation-unlocking-popping open” sequence—while maintaining structural stability and durability—remains an unresolved technical challenge within the industry.

To address the above issues, the present disclosure provides a door lock that effectively overcomes the limitations of existing locks restricted to the “locked-unlocked” binary mechanism, enabling a complete unlocking and door-opening action with one-hand operation from the outside.

### SUMMARY

To overcome the deficiencies of the prior art, the present disclosure provides a door lock, through an innovative integration of a lock catch mechanism and an elastic driving system, enables the stored energy to be automatically released when the switching control assembly is triggered, thereby pushing the door away from the locked position. As a result, the entire unlocking and door-opening process can be completed with a single hand from outside the door, greatly improving usability and enhancing the overall product experience.

The technical solution adopted by the disclosure to solve the above problem is as follows.

A door lock, configured to lock or open a door, the door comprises an inner side, an outer side, and a mounting through hole passing through the inner side and the outer side, the door lock including: a lock bolt, which is fixedly connected to the inner side of the door, and the lock bolt is configured to rotate with a rotation of the door; and a lock catch assembly, which is fixedly connected to the inner side of the door, and the lock catch assembly comprises a fastening state and a releasing state: when the door is in a closed state, the lock catch assembly is in the fastening state, and the lock bolt is fastened by the lock catch assembly; and a switching control assembly, which is fixedly connected to the outer side of the door: when the door is in the closed state, the switching control assembly is configured for switching the lock catch assembly from the fastening state to the releasing state, and during a process of switching the lock catch assembly from the fastening state to the releasing state, the lock bolt automatically pops out of the lock catch assembly and drives the door to rotate to disengage from the closed state.

With the structure described above, the door lock of this achieves functions of single-handed operation and automatic door opening. The user only needs to operate the switching control assembly on the outside of the door to trigger the linkage action. When the lock catch assembly switches from the fastening state to the releasing state, the lock bolt will automatically pop out and directly drive the door leaf to rotate, disengaging from the closed state. This completely resolves the issue with traditional door locks, which require one hand to unlock the door lock and the other hand to push the door. It enables truly convenient one-handed operation, greatly enhancing the user experience, especially in daily scenarios such as carrying items or holding a baby. Meanwhile, the structure is reasonable and the actions are reliable. Through a clever mechanism design, including the cooperation of elastic component, active component, and fixing component within the lock catch assembly, the actions remain smooth and consistent. Additionally, traditional complex transmission mechanisms are reduced, lowering failure rates and improving the overall reliability and service life of the door lock. Furthermore, the door lock offers good safety and clear status. The lock catch assembly has clear fastening state and releasing state. When closing the door, it automatically maintains the fastening state to prevent accidental opening, ensuring the door's safety and sealing. The status transition requires specific actions, making the intent clear and preventing misuse. Moreover, the door lock is highly versatile and adaptable, with a relatively low dependency on door thickness for the core mechanism. The main components are installed on both the inner side and outer side of the door, connected by a flexible traction component that passes through the door body, reducing the need for customized key components for different door thicknesses. This helps simplify production, inventory management, and installation adaptation processes. In summary, this disclosure not only revolutionizes the operation of the door lock but also offers comprehensive optimizations in terms of reliability, safety, and adaptability, with outstanding practical value and market competitiveness.

### BRIEF DESCRIPTION OF DRAWINGS

In order to clearly explain the technical solutions in the embodiments of the present disclosure, the following will provide a brief description of the drawings in the embodiment description. The drawings below are only some embodiments of the present disclosure, and those skilled in the art can, without creative effort, derive other drawings from these. Furthermore, the drawings are not scaled to a 1:1 ratio, and the relative sizes of the components in the drawings are only depicted for illustration, not necessarily to scale.

The disclosure will be further described in conjunction with the drawings and embodiments as follows.

FIG. 1 is a schematic structural diagram of a door lock from a first angle according to an embodiment of the present disclosure.

FIG. 2 is a schematic structural diagram of the door lock from a second angle according to an embodiment of the present disclosure.

FIG. 3 is an exploded view of the door lock of FIG. 1.

FIG. 4 is an exploded view of the door lock of FIG. 2.

FIG. 5 is a first exploded diagram of part of the door lock.

FIG. 6 is a partial schematic structural diagram showing the first abutting portion (including the first abutting position, second abutting position, and unlocking position) and the second abutting portion in mutual contact without external force.

FIG. 7 is an exploded view of a switching control assembly of the door lock of FIG. 1.

FIG. 8 is an exploded view of the switching control assembly of the door lock of FIG. 2.

FIG. 9 is a schematic structural diagram of the door according to an embodiment of the present disclosure.

FIG. 10 is a schematic structural diagram of the door lock installed on the door from the first angle, showing a first abutting portion in a first abutting position, and a second abutting portion is in mutual contact without external force.

FIG. 11 is a schematic structural diagram of the door lock installed on the door from the second angle, showing the first abutting portion in the first abutting position, and the second abutting portion is in mutual contact without external force.

FIG. 12 is a schematic structural diagram of a door lock installed on the door from the first angle, showing the first abutting portion in a second abutting position, and the second abutting portion is in mutual contact without external force.

FIG. 13 is a schematic structural diagram of the door lock installed on the door from the second angle, showing the first abutting portion in the second abutting position, and the second abutting portion is in mutual contact without external force.

FIG. 14 is an enlarged view of an area A in FIG. 10.

FIG. 15 is an enlarged view of an area B in FIG. 12.

FIG. 16 is an enlarged view of an area C in FIG. 13.

Description of the reference numeral:
100 lock bolt, 200 lock catch assembly, 300 switching control assembly, 110 locking rod, 120 handle, 130 fixing seat, 210 fixing component, 211 outer housing, 2111 housing body, 2111a guiding groove, 2111b button mounting hole, 2112 housing cover, 212 inner housing, 2121 first installing shaft, 2122 second installing shaft, 2123 matching portion, 2124 limiting portion, 213 accommodating space, 220 active component, 221 buckling component, 2211 first preload abutting portion, 2212 first abutting portion, 2212a first fastening position, 2212b second fastening position, 2212c unlocking position, 2213 locking portion, 2214 third abutting portion, 222 control component, 2221 second preload abutting portion, 2222 second abutting portion, 2223 triggering portion, 2223a connecting through hole, 230 elastic component, 240 control button, 241 guiding rib, 310 flexible traction component, 311 first connecting end, 312 second connecting end, 320 mounting base, 321 mounting channel, 322 third preload abutting portion, 330 operating component, 331 mounting hole, 332 spiral fastener, 333 connecting component, 3331 auxiliary groove, 334 gripping component, 335 fourth preload abutting portion, 340 preloading spring, 10 door, 11 inner side, 12 outer side, 13 mounting through hole.

### DETAILED DESCRIPTION OF THE EMBODIMENTS

To make the objectives, features, and advantages of the present disclosure more obvious and easier to understand, the following provides a detailed explanation of the specific embodiments of this disclosure in conjunction with the accompanying drawings. In the following description, many specific details are given to facilitate a full understanding of the disclosure. However, the disclosure can be implemented in many different ways other than those described herein, and those skilled in the art can make similar improvements without departing from the scope of this disclosure. Therefore, the disclosure is not limited to the specific embodiments disclosed below.

In the description of this disclosure, it should be understood that if terms such as “center,” “longitudinal,” “lateral,” “length,” “width,” “thickness,” “up,” “down,” “front,” “back,” “left.” “right,” “vertical,” “horizontal,” “top,” “bottom,” “inside,” “outside,” “clockwise,” “counterclockwise,” “axial,” “radial,” and “circumferential” appear, the orientations or positional relationships indicated by these terms are based on the orientations or positional relationships shown in the drawings, for convenience of description, and are not meant to indicate or imply that the devices or components referred to must have specific orientations or be constructed and operated in specific orientations. Therefore, they should not be understood as limiting the scope of the disclosure.

Moreover, if terms such as “first” and “second” appear, these terms are used merely for descriptive purposes and should not be understood to indicate or imply relative importance or imply the number of technical features indicated. Thus, features labeled “first” or “second” may explicitly or implicitly include at least one such feature. In this disclosure, the term “multiple” means at least two, such as two, three, etc., unless otherwise explicitly defined.

In this disclosure, unless otherwise clearly stated, if terms like “mounted,” “connected,” “attached,” or “fixed” are used, these terms should be understood in a broad sense. For example, it could mean fixed connection, removable connection, or integrated: it could be mechanical connection or electrical connection: it could be a direct connection or an indirect connection via an intermediary: it could refer to the internal connection of two components or the interaction between two components, unless explicitly limited. Those skilled in the art can understand the specific meanings of these terms based on the context.

In this disclosure, unless otherwise clearly stated, when the first feature is described as being “on,” “above,” or “below” a second feature, it can mean that the first and second features are in direct contact or indirectly in contact through an intermediate medium. Also, when the first feature is described as being “on,” “above,” or “on top of” the second feature, it may mean that the first feature is directly above or obliquely above the second feature, or it may simply indicate that the first feature is at a higher horizontal level than the second feature. Similarly, when the first feature is described as being “below,” “beneath,” or “underneath” the second feature, it may mean that the first feature is directly below or obliquely below the second feature, or it may simply indicate that the first feature is at a lower horizontal level than the second feature.

It should be noted that if a component is described as being “fixed to” or “arranged on” another component, it may be directly on the other component or may be positioned through a centered component. If one component is described as “connected” to another component, it may be directly connected to the other component or may involve an intermediate component. The terms “vertical,” “horizontal,” “up,” “down,” “left,” “right,” and similar expressions used in this disclosure are for illustrative purposes only and do not represent the only possible implementation.

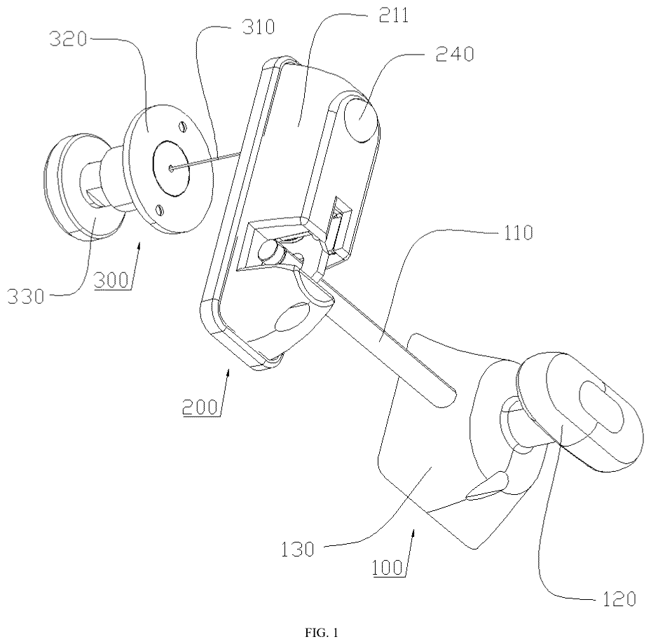

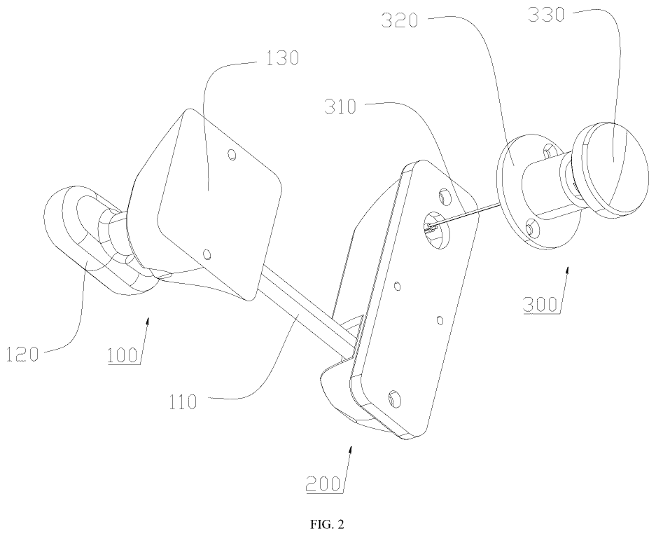

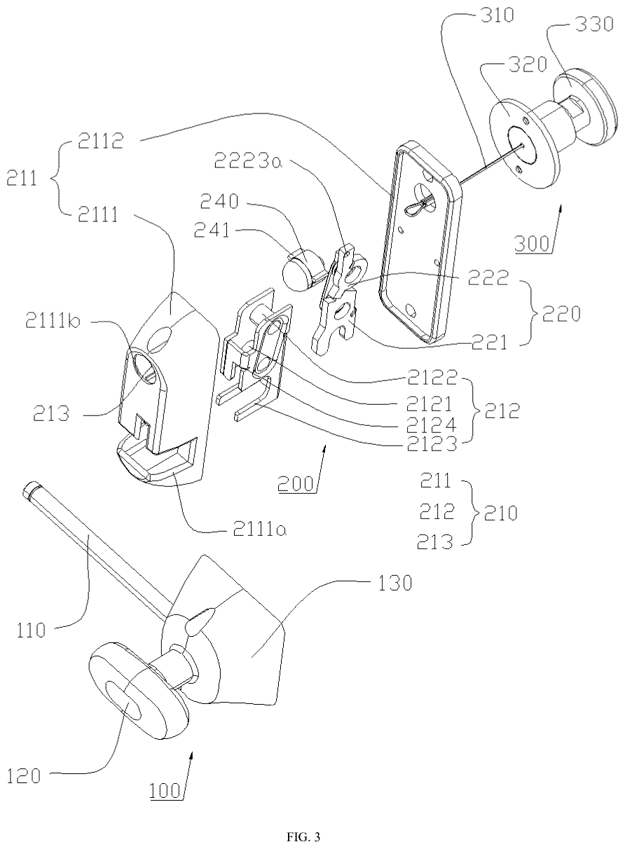

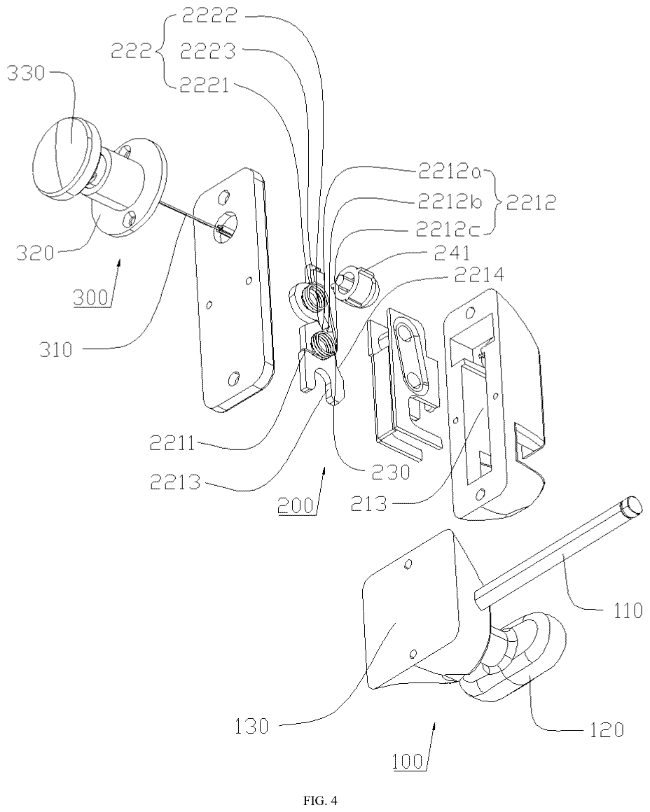

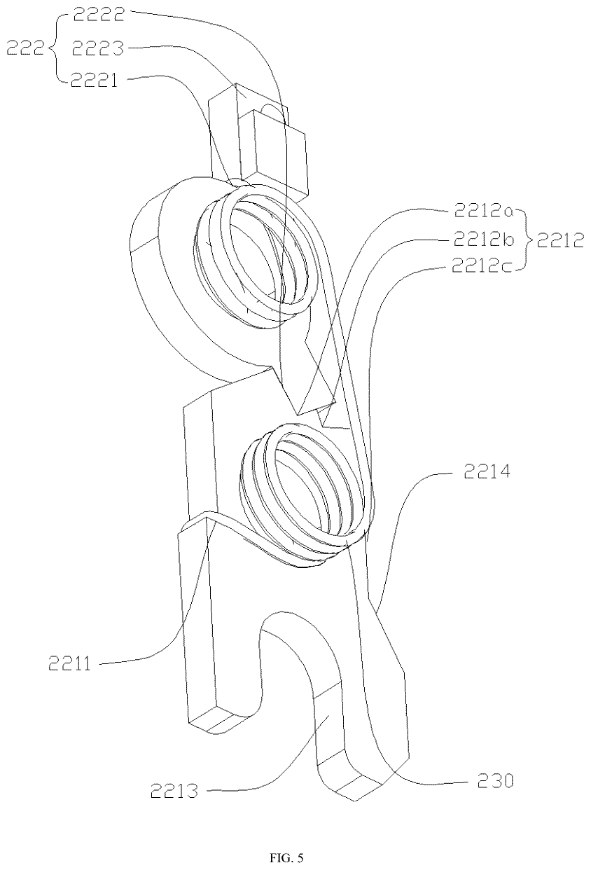

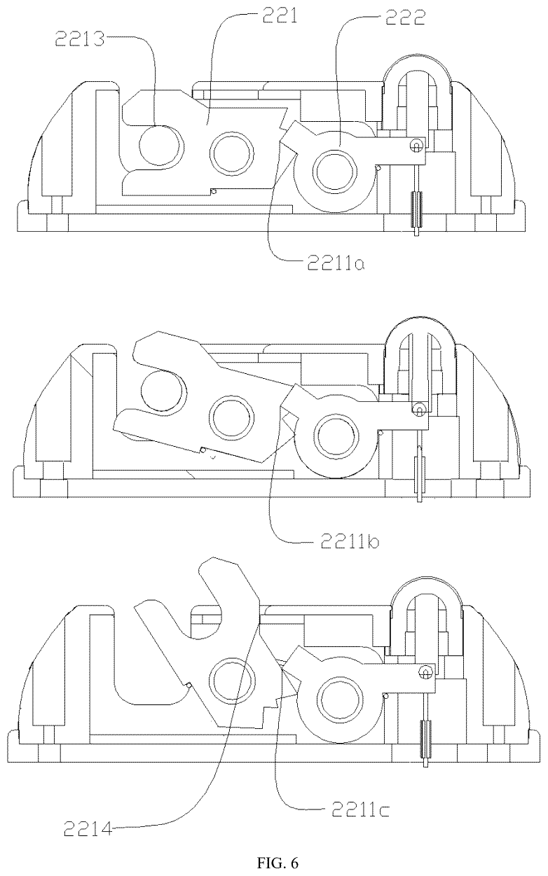

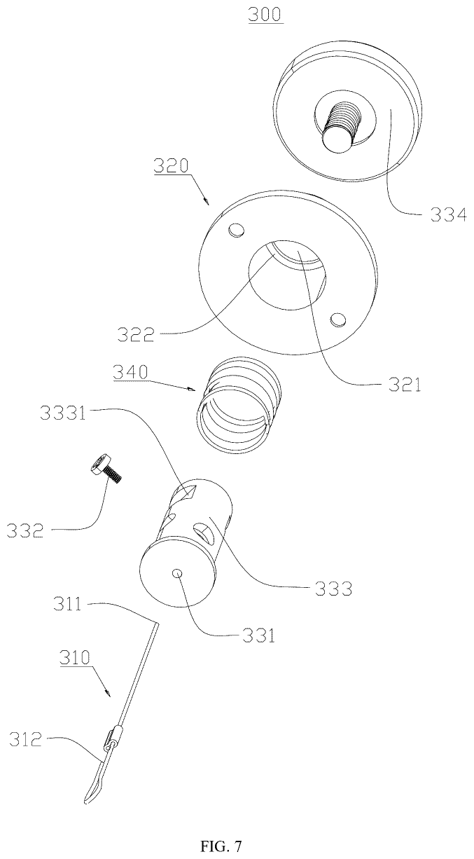

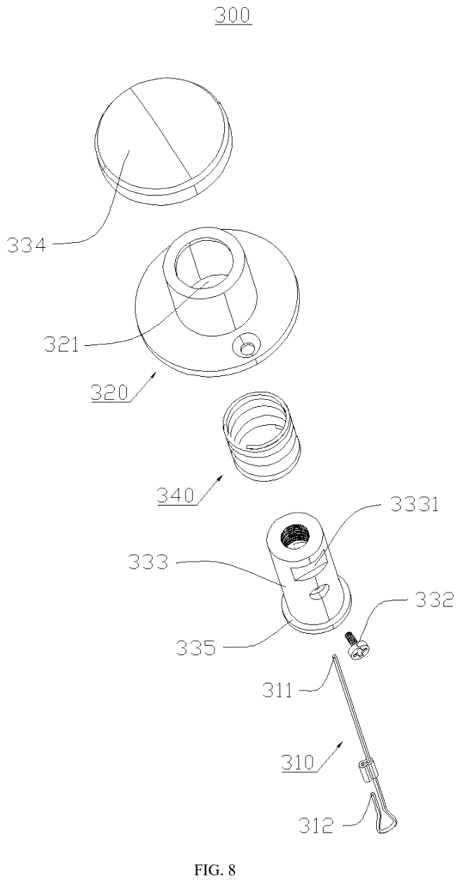

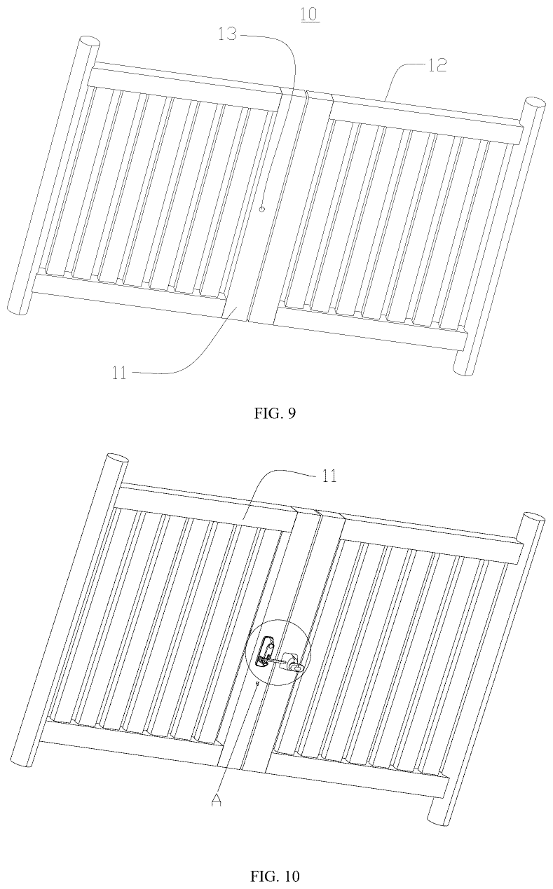

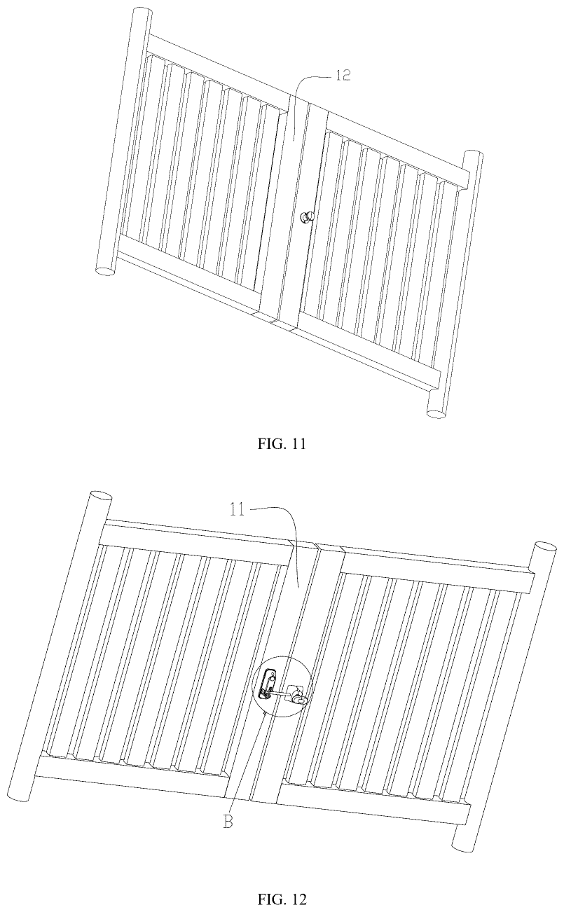

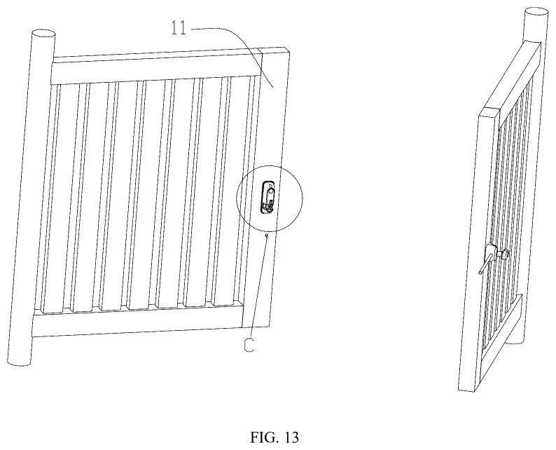

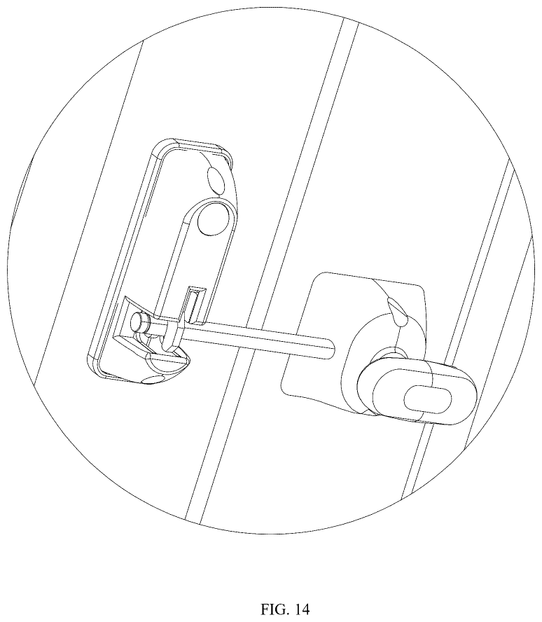

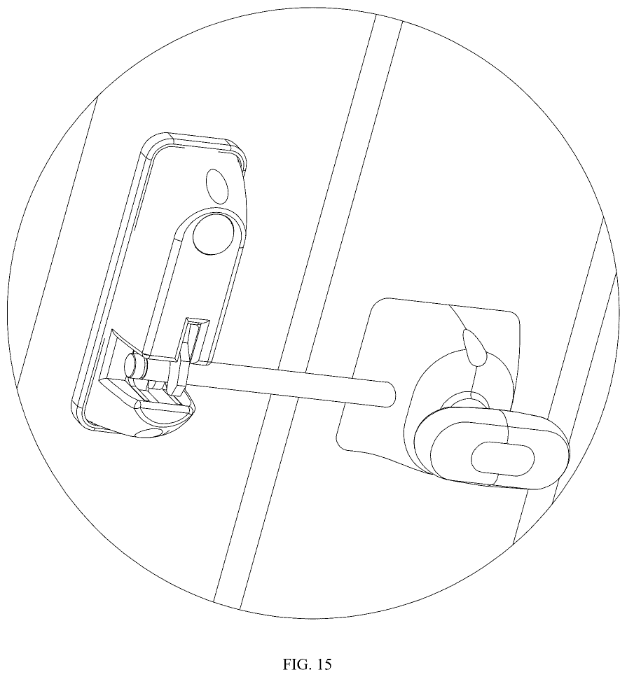

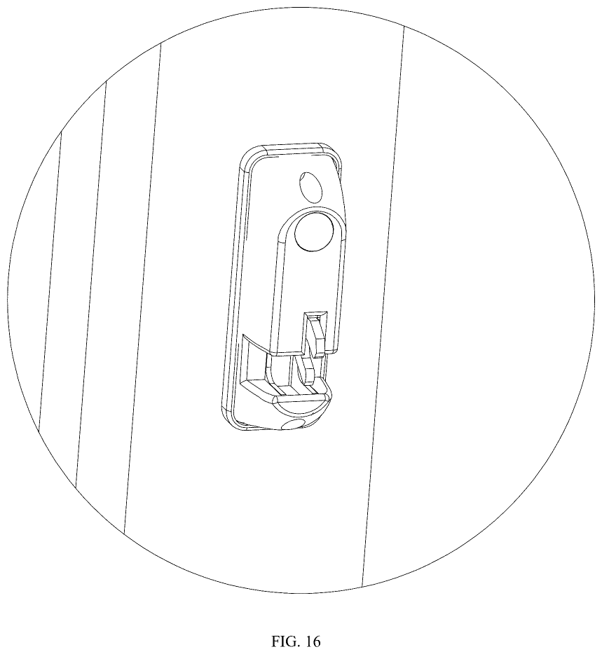

Referring to FIGS. 1 to 16, a door lock for locking or unlocking a door 10, the door 10 includes an inner side 11, an outer side 12, and a mounting through hole 13 passing through both the inner side 11 and the outer side 12. The door lock includes: a lock bolt 100, a lock catch assembly 200 and switching control assembly 300.

The lock bolt 100 is fixedly connected to the inner side 11 of the door 10 and configured to rotate with the rotation of door 10.

The lock catch assembly 200 is fixedly connected to the inner side 11 of door 10. The lock catch assembly 200 includes a fastening state and a releasing state. When door 10 is in the closed state, the lock catch assembly 200 is in the fastening state, and the lock bolt 100 is fastened by the lock catch assembly 200.

The switching control assembly 300 is fixedly connected to the outer side 12 of door 10. When the door 10 is in the closed state, the switching control assembly 300 switches the lock catch assembly 200 from the fastening state to the releasing state. During a process of the lock catch assembly 200 switching from the fastening state to the releasing state, the lock bolt 100 automatically pops out of the lock catch assembly 200 and drives the door 10 to rotate and disengage from the closed state.

Through the above structures, the user only needs to operate the switching control assembly 300 on the outer side 12 of door 10 to trigger a coherent automatic process: the lock catch assembly 200 state switching→the lock bolt 100 automatically popping out→the door 10 opening with rotational thrust. This completely resolves the pain point of traditional door locks requiring “one hand to unlock, and the other to push the door,” greatly enhancing convenience, especially in daily life scenarios such as carrying items or holding a baby. The mechanical structures (such as flexible traction component) link the components on the inner side 11 and outer side 12 of the door 10. An external force on the outer side 12 of the door 10 is accurately transmitted to the inner side 11 of the door 10. Through the internal mechanisms of the lock catch assembly 200 (such as elastic component), stored energy is released to convert into the power to push the lock bolt 100 out. This design is clear in action, responsive, and reliable, reducing failure points. When the door 10 is closed, the lock catch assembly 200 automatically enters and maintains the fastening state, securely holding the lock bolt 100. This provides reliable locking force, effectively preventing accidental opening of the door due to wind, vibration, or impact, ensuring safety and privacy. The entire operation process is intuitive: a single action outside the door completes the opening. Users clearly perceive the feedback on the completion of the operation (e.g., hearing the lock bolt pop out, seeing the door begin to rotate), making the interaction simple and clear. Furthermore, this design typically requires specific and deliberate operations to unlock, preventing security risks from accidental operations. In summary, the core function of this technical solution is to seamlessly integrate the unlocking and door opening actions through clever mechanical design, providing a more convenient, user-friendly, and reliable door lock solution.

In this embodiment, the lock catch assembly 200 includes a fixing component 210, an active component 220, and an elastic component 230. The fixing component 210 is fixedly connected to the inner side 11 of door 10, and the active component 220 is rotatably connected to the fixing component 210. The active component 220 includes a fastening state and a releasing state, and during the process of the active component 220 switching from the fastening state to the releasing state, the elastic component 230 applies elastic force to the lock bolt 100 via the active component 220, causing the lock bolt 100 to automatically pop out of the lock catch assembly 200 and drive the door 10 to rotate and disengage from the closed state.

With the above structures, during use, the energy storage of the elastic component 230 does not come from the user's operation when opening the door, but is automatically completed during the door closing process. The user's operation on the outer side 12 of the door 10 merely serves as a trigger signal to release the energy that has been previously stored. This greatly simplifies the amount of effort required by the user to open the door, achieving true “effort-saving.” The user only needs a very light trigger force (such as a pull force) to release the larger energy stored during the door closing process, causing the door to pop and open, creating a very light and efficient experience.

It is important to note that in this embodiment, the actions of “energy storage” and “energy release” are completely separated in time. Since the elastic energy comes from the natural action of closing the door, the amount of energy stored (i.e., a degree of twisting of the elastic component 230) is determined by the door's closed state, providing a consistent energy reserve with every door closing. This ensures that the force and effect of automatic door opening are stable and reliable, regardless of how fast or slow the user operates the door or how much force is applied, ensuring effective automatic door opening and avoiding situations where improper operation leads to insufficient opening force or failure. The energy storage process, which involves high intensity and large travel, is combined with the natural action of closing the door, while the trigger action, which involves light force and small travel, is left to the opening operation. This design rationally distributes the mechanical stress conditions of the components. The components responsible for most of the energy storage (such as the elastic component 230) experience slow and single-force loads, while the outer door operation components (such as handles or buttons) only bear a very small triggering force. This extends the lifespan of all components and makes the force flow design of the entire system more scientific and durable.

In summary, the core function of this technical solution is no longer simply to “use the elastic component to pop the door open,” but rather to cleverly separate the actions of “closing the door for energy storage-operating for energy release,” achieving the most stable and powerful automatic door opening effect with minimal user operation cost, while achieving excellent levels of structural reliability and user experience.

In this embodiment, the fixing component 210 includes an outer housing 211 and an inner housing 212. The outer housing 211 is fixedly connected to the inner side 11 of the door 10 and defined with an accommodating space 213. The inner housing 212 is located inside the accommodating space 213, and the active component 220 is rotatably connected to the inner housing 212.

With the above structures, during use, the outer housing 211, as the first protective barrier directly mounted on the outer side 12 of the door 10, effectively protects the internal components, such as the inner housing 212 and active component 220, from dust, foreign objects, or human damage, improving the durability and reliability of the product. The inner housing 212, as an independent structure, is pre-assembled with the active component 220 and other components and then inserted into the accommodating space 213 of the outer housing 211. This greatly simplifies the on-site installation and subsequent maintenance process, improving production and installation efficiency. The inner housing 212 provides a solid and precise mounting base for the rotation of the active component 220, ensuring the accuracy and consistency of the movement trajectory of the active component 220, thereby ensuring the reliable execution of the locking and releasing actions. The outer housing 211 is composed of the housing body 2111 and the housing cover 2112, the housing body 2111 is defined with a guiding groove 2111a and a button mounting hole 2111b.

In this embodiment, the inner housing 212 has a first installing shaft 2121 and a second installing shaft 2122. The active component 220 includes a buckling component 221 and a control component 222. The buckling component 221 is rotatably connected to the first installing shaft 2121, and the control component 222 is rotatably connected to the second installing shaft 2122. The elastic component 230 abuts against the buckling component 221 and the control component 222 to ensure that the buckling component 221 and the control component 222 are in mutual contact without external force.

Through the above structures, during use, by subdividing the active component 220 into the buckling component 221 and the control component 222, and mounting them on a first installing shaft 2121 and a second installing shaft 2122 respectively, the locking function (performed by the buckling component 221) is separated from the control and triggering function (performed by the control component 222). These two functions are coupled through the preloading force of the elastic component 230, allowing a light operational force on the outer side of the door (acting on the control component 222) to reliably trigger a strong lock release action inside the door (performed by the buckling component 221), achieving an “effort-saving” effect. The elastic component 230 continuously applies a preloading force to the buckling component 221 and the control component 222, forcing them into mutual contact. This component 221 has a first preload abutting portion 2211 and a first abutting portion 2212. The control component 222 has a second preload abutting portion 2221 and a second abutting portion 2222. The elastic component 230 abuts against the first preload abutting portion 2211 and the second preload abutting portion 2221 and applies an elastic preloading force to them, ensuring that the first abutting portion 2212 and the second abutting portion 2222 are in mutual contact in the absence of external forces.

Through the above structures, during use, by setting the first preload abutting portion 2211 and the second preload abutting portion 2221 to precisely receive the preloading force of the elastic component 230, and using the mutual contact between the first abutting portion 2212 and the second abutting portion 2222 to transmit movement and maintain the state, the core function is: to optimize the transmission path of the elastic preloading force, ensuring the precise and stable interrelationship between the buckling component 221 and the control component 222, thus allowing a light operational force outside the door to reliably trigger the strong release of the lock bolt inside the door, achieving an effort-saving and reliable one-handed automatic door opening.

In this embodiment, the buckling component 221 is further provided with a locking portion 2213, and the inner housing 212 is further provided with a matching portion 2123. The first abutting portion 2212 includes a first fastening position 2212a, a second fastening position 2212b, and an unlocking position 2212c. When the first abutting portion 2212 and the second abutting portion 2222 are respectively abutting at the first fastening position 2212a and the second fastening position 2212b, the matching portion 2123 is coupled with the locking portion 2213, thereby fastening the lock bolt 100 between the matching portion 2123 and the locking portion 2213, making the lock catch assembly 200 in the fastening state. When the first abutting portion 2212 and the second abutting portion 2222 are abutting at the unlocking position 2212c, the matching portion 2123 and the locking portion 2213 decouple, causing the lock bolt 100 to automatically pop out from between the matching portion 2123 and the locking portion 2213, thereby making the lock catch assembly 200 in the releasing state. Through these structures, the coupling and decoupling mechanism of the locking portion 2213 and the matching portion 2123, along with the multiple precise positioning points of the first abutting portion 2212, creates a stable, reliable, and fault-tolerant bistable locking structure. Particularly, the setting of the second fastening position 2212b enables it to effectively adapt to misalignment and uneven conditions that may occur when the fence door closes, ensuring that under non-ideal conditions, the lock catch assembly 200 can still securely fasten the lock bolt 100, and instantly decouple and release upon triggering, reliably and automatically popping open the door leaf. This greatly enhances the product's adaptability and reliability in practical applications.

In this embodiment, the buckling component 221 is further provided with a third abutting portion 2214, and the control component 222 is further provided with a triggering portion 2223. The inner housing 212 is also provided with a limiting portion 2124. When the triggering portion 2223 is acted upon by an external force, the control component 222 overcomes the elastic preloading force provided by the elastic component 230 and rotates until it is no longer in an abutting state with the first abutting portion 2212, at which point the limiting portion 2124 abuts against the third abutting portion 2214, and the lock catch assembly 200 is in the releasing state. At this moment, if the external force is removed, the first abutting portion 2212 and the second abutting portion 2222, driven by the elastic preloading force, remain in abutment at the unlocking position 2212c. Through these structures, by setting up the third abutting portion 2214, the triggering portion 2223, and the limiting portion 2124 in coordination, not only is the release state stably maintained, but more importantly, during the subsequent door closing process, this coordination mechanism automatically and reliably guides the buckling component 221 and the control component 222 to recouple and lock in the first fastening position 2212a or the second fastening position 2212b, thereby allowing the elastic component 230 to complete energy storage, preparing for the next automatic popping open of the door, realizing the cycle automation from “release” to “recharging.”

In this embodiment, the switching control assembly 300 includes a flexible traction component 310, a mounting base 320, and an operating component 330. The operating component 330 is movably connected to the mounting base 320, and the mounting base 320 is fixedly connected to the outer side 12 of the door 10. The triggering portion 2223 is provided with a connecting through hole 2223a. The flexible traction component 310 includes a first connecting end 311 and a second connecting end 312. The second connecting end 312 is connected to the triggering portion 2223 through the connecting through hole 2223a, and the first connecting end 311 passes through the mounting hole 13 and connects to the operating component 330. By pulling the flexible traction component 310 and the triggering portion 2223 through the operating component 330, the control component 222 overcomes the elastic preloading force provided by the elastic component 230 and rotates, until it is no longer in an abutting state with the first abutting portion 2212, and ultimately switches the lock catch assembly 200 from the fastening state to the releasing state. During this process of the lock catch assembly 200 transitioning from the fastening state to the releasing state, the matching portion 2123 and the locking portion 2213 decouple, and under the action of the elastic preloading force provided by the elastic component 230, the lock bolt 100 automatically pops out from between the matching portion 2123 and the locking portion 2213, and drives the door 10 to rotate and detach from the closed state. Through these structures, the flexible traction component 310 connects the operating component 330 (exterior door) to the triggering portion 2223 (interior door), converting the simple external pulling operation of the user into precise control over the internal mechanism of the lock catch assembly 200, thus triggering the release of the lock in a light and effortless manner. This design effectively utilizes the pre-stored energy of the elastic component 230, enabling the automatic popping out of the lock bolt 100 and the smooth opening of the door leaf, while simplifying the mechanical linkage between the internal and external door components, improving installation adaptability and operational convenience.

In this embodiment, the operating component 330 is provided with a mounting hole 331 and a spiral fastener 332. The first connecting end 311 is inserted into the mounting hole 331 and is fixedly connected to the operating component 330 through the spiral fastener 332. Through these structures, the simple coordination of the mounting hole 331 and the spiral fastener 332 ensures a firm and adjustable connection between the flexible traction component 310, the first connecting end 311, and the operating component 330, guaranteeing the efficient and reliable transmission of the operating force from the exterior to the interior of the door, while greatly facilitating installation and later maintenance or replacement.

In this embodiment, the operating component 330 includes a connecting component 333 and a gripping component 334. The gripping component 334 and the connecting component 333 are connected by threads. Through these structures, by separating the operating component 330 into a connecting component 333 and a gripping component 334 connected by threads, the installation debugging and operation functions are separated. these structures not only allow precise adjustment of the tension of the flexible traction component 310 by rotating the gripping component 334 to ensure effective transmission of operating force, but also makes the gripping component 334 independently replaceable, improving the modularity and ease of maintenance.

In this embodiment, the switching control assembly 300 further includes a preloading spring 340. The mounting base 320 is provided with a mounting channel 321, and the preloading spring 340 is sleeved over the connecting component 333. The connecting component 333 passes through the mounting channel 321 and is connected to the gripping component 334 by threads. Through these structures, by modularizing the operating component 330 into a connecting component 333 and a gripping component 334 using thread connections, the compactness of the structure is maintained, while enabling the independent replaceability of the gripping component 334, reducing maintenance costs.

In this embodiment, the mounting base 320 is provided with a third preloading abutting portion 322, which is located at an end of the mounting channel 321 away from the door 10, and the inner diameter of the third preloading abutting portion 322 is smaller than the inner diameter of the mounting channel 321. The operating component 330 is provided with a fourth preloading abutting portion 335, which is located at an end of the connecting component 333 close to the door 10. An outer diameter of the fourth preloading abutting portion 335 is smaller than an inner diameter of the mounting channel 321 but larger than an inner diameter of the third preloading abutting portion 322. Both ends of the preloading spring 340 abut against the third preloading abutting portion 322 and the fourth preloading abutting portion 335, respectively. Through these structures, the third preloading abutting portion 322 and the fourth preloading abutting portion 335 precisely limit and support the preloading spring 340 for the exterior operation and maintaining the compactness and stability of the entire operating mechanism.

In this embodiment, the connecting component 333 is defined with an auxiliary groove 3331, which is used to prevent the connecting component 333 from rotating when it is threadedly connected with the gripping component 334. With this structural arrangement, the auxiliary groove 3331 effectively prevents relative rotation during threaded assembly with the gripping component 334, ensuring the stable relative positioning of the preloaded spring 340 and internal structures during assembly, thus guaranteeing the assembly accuracy and overall reliability of the operating component 330.

In this embodiment, the lock bolt 100 includes a locking rod 110, a handle 120, and a fixing seat 130. With this modular design, the lock bolt 100 integrates functionality and structural optimization: the locking rod 110 directly engages with the locking mechanism to ensure secure locking: the handle 120 provides a manual contact point (e.g., for manually closing the door), enhancing usability; and the fixing seat 130 ensures firm installation to the door body, collectively improving the component's functionality, usability, and assembly stability.

In this embodiment, the elastic component 230 is a torsion spring. This choice leverages the torsion spring's ability to provide rotational elastic force, supplying stable and reliable torque for the rotation and reset of the buckling component 221 and the control component 222. It ensures precise and smooth switching actions of the lock catch assembly 200 between the fastening state and the releasing state, while its compact structure is well-suited for the primarily rotational internal mechanism in the door lock.

In this embodiment, the lock catch assembly 200 further includes a control button 240. The outer housing 211 is provided with a button mounting hole 2111b. The control button 240 passes through the button mounting hole 2111b from the inner side 11 of the accommodating space 213 and is movably connected to the outer housing 211. One end of the control button 240 inside the accommodating space 213 abuts against the triggering portion 2223. The control button 240 provides users with a manual method for triggering the release of the lock catch assembly 200 from the door's inner side 11, enhancing convenience and safety, and achieving integrated dual control from both sides of the door.

In this embodiment, the control button 240 is provided with a guiding rib 241, and the outer housing 211 is defined with a guiding groove 2111a. The control button 240 is slidably connected to the outer housing 211 via the guiding groove 2111a and the guiding rib 241. This sliding fit ensures smooth linear motion of the control button 240 within the outer housing 211, effectively preventing deviation or jamming during pressing, thereby improving operational smoothness, tactile consistency, and component durability.

In this embodiment, a pressing portion of the control button 240 that protrudes from the outer housing 211 is hemispherical. This ergonomic design enhances pressing comfort and, more importantly, the hemispherical protrusion makes it difficult for external individuals to exert force or pry it open with tools, thereby significantly increasing resistance to unauthorized access and improving the anti-tampering and anti-theft performance of the door lock.

In this embodiment, the outer housing 211 is made of zinc alloy. The selection of zinc alloy capitalizes on its excellent corrosion and rust resistance, effectively protecting against moisture in the air and corrosive substances in daily use. This ensures the long-term integrity of the appearance and reliability of the internal structure of the lock catch assembly 200 in harsh environments such as high humidity, greatly extending product lifespan. Additionally, the high strength, hardness, and superior casting performance of zinc alloy provide robust external protection for the lock catch assembly 200, effectively resisting external impacts and prying attempts, thereby enhancing the security and overall durability of the product. Its good processability also facilitates the manufacturing of complex outer housing structures.

In this embodiment, the outer housing 211 is fixedly connected to the inner side 11 of the door 10 by a threaded fastener. This configuration ensures secure and stable installation of the lock catch assembly 200, effectively preventing loosening caused by vibrations or impacts during use. Moreover, this standardized connection method allows for easy disassembly, facilitating future maintenance and replacement.

The above description presents one or more embodiments based on specific implementation details and should not be interpreted as limiting the disclosure exclusively to these examples. Any methods or structures that are similar or approximate, or any technical variations or substitutions made under the conceptual framework of this disclosure, shall be regarded as within the scope of protection of the present disclosure.

What is claimed is:

1. A door lock, configured to lock or open a door, the door comprises an inner side, an outer side, and a mounting through hole passing through the inner side and the outer side, wherein the door lock comprising:
a lock bolt, which is fixedly connected to the inner side of the door, and the lock bolt is configured to rotate with a rotation of the door; and
a lock catch assembly, which is fixedly connected to the inner side of the door, and the lock catch assembly comprises a fastening state and a releasing state; when the door is in a closed state, the lock catch assembly is in the fastening state, and the lock bolt is fastened by the lock catch assembly; and
a switching control assembly, which is fixedly connected to the outer side of the door; when the door is in the closed state, the switching control assembly is configured for switching the lock catch assembly from the fastening state to the releasing state, and during a process of switching the lock catch assembly from the fastening state to the releasing state, the lock bolt automatically pops out of the lock catch assembly and drives the door to rotate to disengage from the closed state.

2. The door lock according to claim 1, wherein the lock catch assembly comprises a fixing component, an active component, and an elastic component:
wherein the fixing component is fixedly connected to the inner side of the door, the active component is rotatably connected to the fixing component, and the active component comprises the fastening state and the releasing state;
during a process of the active component switching from the fastening state to the releasing state, the elastic component applies an elastic force to the lock bolt through the active component, causing the lock bolt to automatically pop out of the lock catch assembly, thereby driving the door to rotate and disengage from the closed state.

3. The door lock according to claim 2, wherein the fixing component comprises an outer housing and an inner housing: wherein the outer housing is fixedly connected to the inner side of the door, and the outer housing is defined with an accommodating space; the inner housing is placed in the accommodating space, and the active component is rotatably connected to the inner housing.

4. The door lock according to claim 3, wherein the inner housing is provided with a first installing shaft and a second installing shaft: the active component comprises a buckling component and a control component:
wherein the buckling component is rotatably connected to the first installing shaft, and the control component is rotatably connected to the second installing shaft: the elastic component is abutted on the buckling component and the control component, leading the buckling component and the control component abut each other without external force.

5. The door lock according to claim 4, wherein the buckling component comprises a first preload abutting portion and a first abutting portion, and the control component comprises a second preload abutting portion and a second abutting portion:
wherein the elastic component is abutted on the first preload abutting portion and the second preload abutting portion, the elastic component is configured to apply an elastic pre-tightening force to the first preload abutting portion and the second preload abutting portion: to lead the first abutting portion and the second abutting portion abut each other without external force.

6. The door lock according to claim 5, wherein the buckling component further comprises a locking portion, and the inner housing further comprises a matching portion:
wherein the first abutting portion comprises a first fastening position, a second fastening position, and an unlocking position;
when the first abutting portion and the second abutting portion respectively abut at the first fastening position and the second fastening position, the matching portion engages with the locking portion, thereby fastening the lock bolt between the matching portion and the locking portion, making the lock catch assembly in the fastening state;
when the first abutting portion and the second abutting portion abut at the unlocking position, the matching portion and the locking portion disengage, causing the lock bolt to automatically pop out from between the matching portion and the locking portion, thereby making the lock catch assembly in the releasing state.

7. The door lock according to claim 6, wherein the buckling component is provided with a third abutting portion, and the control component is provided with a triggering portion, the inner housing is provided with a limiting portion:
when the triggering portion is subjected to an external force, the control component overcomes the elastic pre-tightening force provided by the elastic component and rotates until it disengages from the first abutting portion, leading the limiting portion to contact the third abutting portion, and the lock catch assembly is in the releasing state;
if the external force is removed at this point, the first abutting portion and the second abutting portion remain in contact at the unlocking position under a driving force of the elastic pre-tightening force.

8. The door lock according to claim 7, wherein the switching control assembly comprises a flexible traction component, a mounting base, and an operating component:
wherein the operating component is actively connected to the mounting base, and the mounting base is fixedly connected to the outer side of the door;
the triggering portion is defined with a connecting through hole; the flexible traction component comprises a first connecting end and a second connecting end; the second connecting end is connected to the triggering portion via the connecting through hole, and the first connecting end is passed through the mounting through hole and connected to the operating component;
the flexible traction component and the triggering portion are pulled by the operating component, thereby driving the control component to overcome the elastic pre-tightening force provided by the elastic component and rotate until it disengages from the first abutting portion, and ultimately switches the lock catch assembly from the fastening state to the releasing state;
during the process of switching the lock catch assembly from the fastening state to the releasing state, the matching portion disengages from the locking portion, and the lock bolt automatically pops out from between the matching portion and the locking portion, driving the door to rotate and disengage from the closed state.

9. The door lock according to claim 8, wherein the operating component has a mounting hole and a spiral fastener, and the first connecting end is inserted into the mounting hole and fixedly connected to the operating component via the spiral fastener.

10. The door lock according to claim 9, wherein the operating component comprises a connecting component and a gripping component, and the gripping component is threaded with the connecting component.

11. The door lock according to claim 10, wherein the switching control assembly further comprises a preloading spring, and the mounting base is defined with a mounting channel: the preloading spring is sleeved on the connecting component and passed through the mounting channel along with the connecting component and threadedly connected to the gripping component.

12. The door lock according to claim 11, wherein the mounting base is provided with a third preload abutting portion, the third preload abutting portion is located at an end of the mounting channel away from the door; and an inner diameter of the third preload abutting portion is smaller than an inner diameter of the mounting channel:
the operating component is provided with a fourth preload abutting portion, the fourth preload abutting portion is located at an end of the connecting component near the door, and an outer diameter of the fourth preload abutting portion is smaller than the inner diameter of the mounting channel and larger than the inner diameter of the third preload abutting portion: two ends of the preloading spring are abutted against the third preload abutting portion and the fourth preload abutting portion, respectively.

13. The door lock according to claim 11, wherein the connecting component is defined with an auxiliary groove, which is configured to prevent the connecting component from rotating when it is threadedly connected to the gripping component.

14. The door lock according to claim 1, wherein the lock bolt comprises a locking rod, a handle, and a fixing seat.

15. The door lock according to claim 2, wherein the elastic component is a torsion spring.

16. The door lock according to claim 7, wherein the lock catch assembly further comprises a control button, the outer housing is provided with a button mounting hole, and the control button is movably connected to the housing by passing through the button mounting hole from an inner side of the accommodating space, with one end of the control button abutting against the triggering portion inside the accommodating space.

17. The door lock according to claim 16, wherein the control button is provided with a guiding rib, and the outer housing is defined with a guiding groove, the control button is slidably connected to the outer housing through the guiding groove and the guiding rib.

18. The door lock according to claim 16, wherein a pressing portion of the control button protruding from the housing is hemispherical.

19. The door lock according to claim 16, wherein a material of the housing is zinc alloy.

20. The door lock according to claim 3, wherein the housing is fixedly connected to the inner side of the door by a threaded fastener.
